(19) United States
(12) Patent Application Publication
(10) Pub. No.: US 2025/0284703 A1
(43) Pub. Date: Sep. 11, 2025

(54) COMMUNICATING VIA A COMMUNICATION CHANNEL IDENTIFIED FROM AN EXTRACT, TRANSFORM, AND LOAD PROCESS

(71) Applicant: Capital One Services, LLC, McLean, VA (US)

(72) Inventor: Asutosh PANDYA, McKinney, TX (US)

(21) Appl. No.: 18/599,636

(22) Filed: Mar. 8, 2024

(51) Int. Cl. G06F 16/25

(52) U.S. Cl. CPC G06F 16/254

(57) ABSTRACT

In some implementations, a device may obtain raw data including events data indicating a series of events involving interactions between an entity and an individual, and including identity data for the individual. The device may process the raw data to determine, based on the events data and the identity data, a communication type, a communication channel, and a content for a communication to the individual. The device may generate, in accordance with processing the raw data, communication data that includes the content and has a format used for the communication channel. The device may transmit the communication data for an endpoint of the communication channel to cause transmission of the communication, including the content and using the communication type, via the communication channel.

### BACKGROUND

A communication device may transmit communications by email, text message, automated phone calls, or the like. In some examples, the communication device may transmit hundreds, thousands, or even millions of communications over a relatively short period of time. Sometimes, a recipient of a communication may not open, read, answer, or respond to the communication.

### SUMMARY

Some implementations described herein relate to a system for communicating via a communication channel based on an extract, transform, and load (ETL) process. The system may include one or more memories and one or more processors communicatively coupled to the one or more memories. The one or more processors may be configured to obtain raw data including events data indicating a series of events involving interactions between an entity and an individual, and including identity data for the individual. The one or more processors may be configured to load the raw data into a first container to initiate an ETL process. The one or more processors may be configured to extract, in connection with an extract phase of the ETL process, the raw data from the first container. The one or more processors may be configured to process, in connection with a transform phase of the ETL process, the raw data to determine, based on the events data and the identity data, a communication type, a communication channel, and a content for a communication to the individual. The one or more processors may be configured to transform, in connection with the transform phase of the ETL process, the raw data into communication data that includes the content and has a format used for the communication channel. The one or more processors may be configured to load, in connection with a load phase of the ETL process, the communication data into a second container to initiate a communication action. The one or more processors may be configured to transmit, in connection with the communication action, the communication data for an endpoint of the communication channel to cause transmission of the communication, including the content and using the communication type, via the communication channel.

Some implementations described herein relate to a method of communicating via a communication channel based on an ETL process. The method may include obtaining, by a device, raw data including events data indicating a series of events involving interactions between an entity and an individual, and including identity data for the individual. The method may include processing, by the device, the raw data to determine, based on the events data and the identity data, a communication type, a communication channel, and a content for a communication to the individual. The method may include generating, by the device and in accordance with processing the raw data, communication data that includes the content and has a format used for the communication channel. The method may include transmitting, by the device, the communication data for an endpoint of the communication channel to cause transmission of the communication, including the content and using the communication type, via the communication channel.

Some implementations described herein relate to a non-transitory computer-readable medium that stores a set of instructions for communicating via a communication channel based on an ETL process. The set of instructions, when executed by one or more processors of a device, may cause the device to obtain raw data indicating at least one of: events data indicating a series of events involving interactions between an entity and an individual, or identity data for the individual. The set of instructions, when executed by one or more processors of the device, may cause the device to process the raw data to determine, based on at least one of the events data or the identity data, a communication channel for a communication to the individual. The set of instructions, when executed by one or more processors of the device, may cause the device to generate, based on the raw data, communication data that has a format used for the communication channel. The set of instructions, when executed by one or more processors of the device, may cause the device to transmit the communication data for an endpoint of the communication channel to cause transmission of the communication via the communication channel.

### BRIEF DESCRIPTION OF THE DRAWINGS

FIGS. 1A-1C are diagrams of an example associated with communicating via a communication channel identified from an ETL process, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with communicating via a communication channel identified from an ETL process, in accordance with some embodiments of the present disclosure.

FIG. 4 is a flowchart of an example process associated with communicating via a communication channel identified from an ETL process, in accordance with some embodiments of the present disclosure.

### DETAILED DESCRIPTION

The following detailed description of example implementations refers to the accompanying drawings. The same reference numbers in different drawings may identify the same or similar elements.

Communications may be transmitted by email, text message, automated phone calls, or the like. In general, the transmission of a single communication may use minimal computing resources (e.g., memory resources, processor resources, or the like) of the transmitter and minimal resources of a communications network on which the communication is transmitted. However, commonly, an entity may be engaged in operations that call for the transmission of hundreds, thousands, or even millions of communications, which in the aggregate place a significant burden on computing resources and network resources. A communication type and/or a communication channel used for a communication (e.g., a communication channel that utilizes text messages, a communication channel that utilizes email, or the like) may play a role in whether a recipient engages with the communication (e.g., opens the communication, reads the communication, responds to the communication, or the like). Thus, by transmitting communications without regard to communication channel, significant computing resources and network resources may be expended in an inefficient manner. A communication including content that is relevant to a recipient also may play a role in whether a recipient engages with the communication. Thus, by transmitting communications with content that lacks relevancy to recipients, significant computing resources and network resources may be expended in an inefficient manner.

Some implementations described herein utilize an extract, transform, load (ETL) process to identify an advantageous communication type, communication channel, and/or content for a communication. The ETL process may transform raw data into communication data that can be sent to an endpoint for a communication channel to cause transmission of a communication. The raw data may indicate events data, indicating a series of events involving interactions between an entity and an individual, and identity data for the individual (e.g., indicating basic information associated with the individual, such as an age, occupation, annual salary, or the like). By processing and analyzing characteristics of the events data and the identity data, an optimal communication type, communication channel, and content can be identified. Thus, the raw data may be transformed into the communication data that includes the content and that has a format used for the communication type and/or the communication channel. The communication data may then be transmitted, without further modification or additional processing, to the endpoint for the communication channel to cause transmission, via the communication channel, of a communication that includes the content and uses the communication type. Using an appropriate communication type, communication channel, and content improves a probability that the individual will engage with the communication. In this way, computing resources and network resources used for transmitting communications are utilized more efficiently.

In some implementations, the ETL process may be implemented using a cloud-based serverless platform. For example, the ETL process may be performed using an event-driven framework that utilizes cloud-based services, such as cloud-based serverless compute functions, cloud-based containers, and a cloud-based ETL service. In this way, the ETL process may be highly scalable, resilient to fluctuating data sizes, and highly secure. Accordingly, the ETL process may handle large amounts of raw data that provides for improved accuracy in identifying an optimal communication type, communication channel, and/or content. Furthermore, the ETL process may transform the large amounts of raw data into communication data that is much smaller, thereby reducing computing resources and/or network resources that are used for communication with the endpoint for the communication channel.

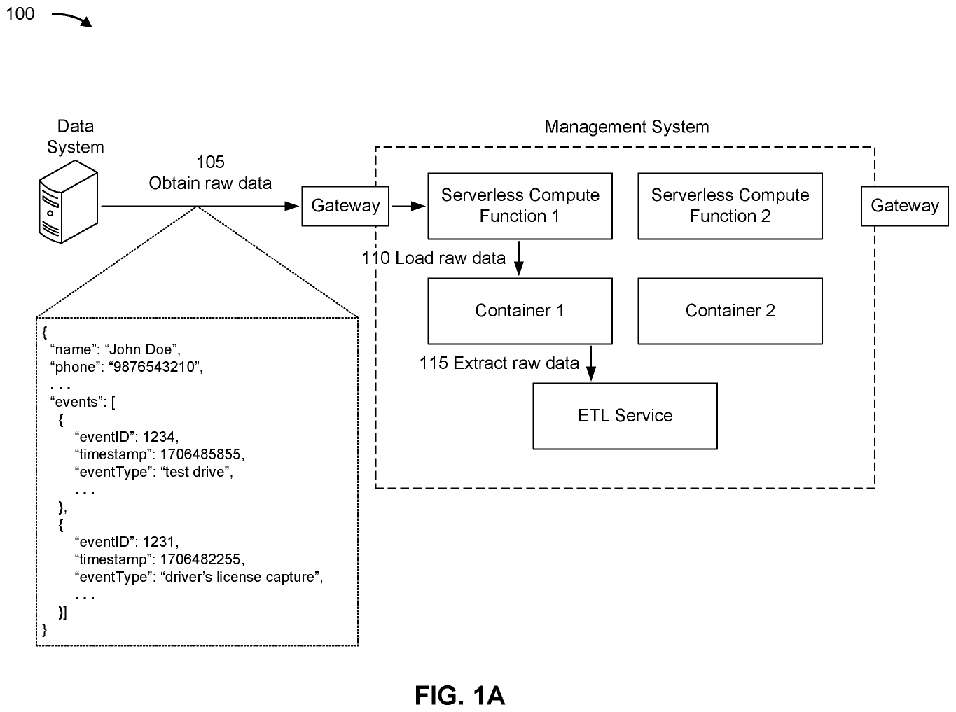

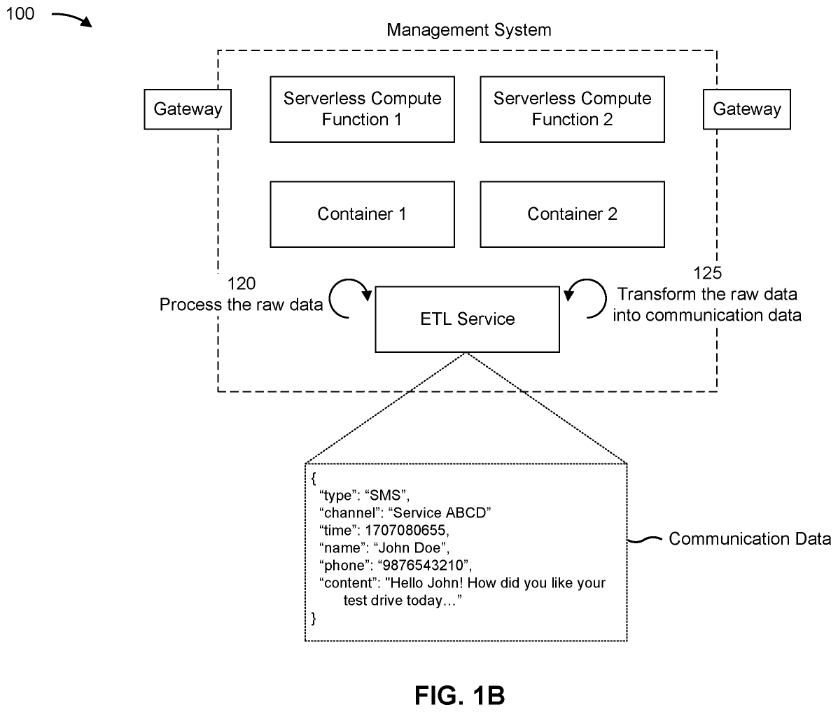

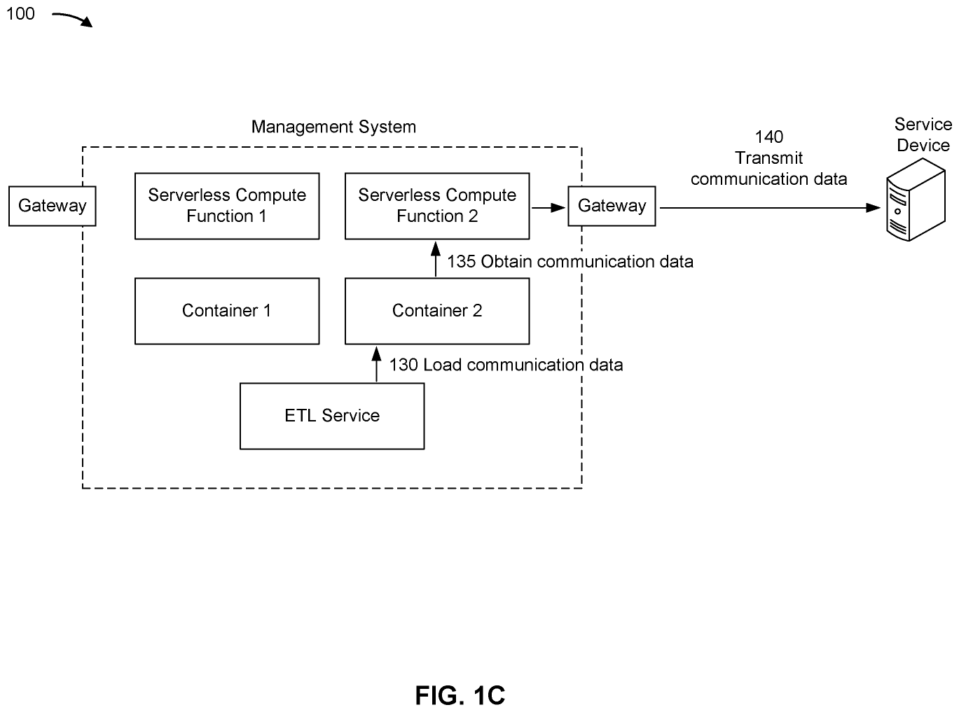

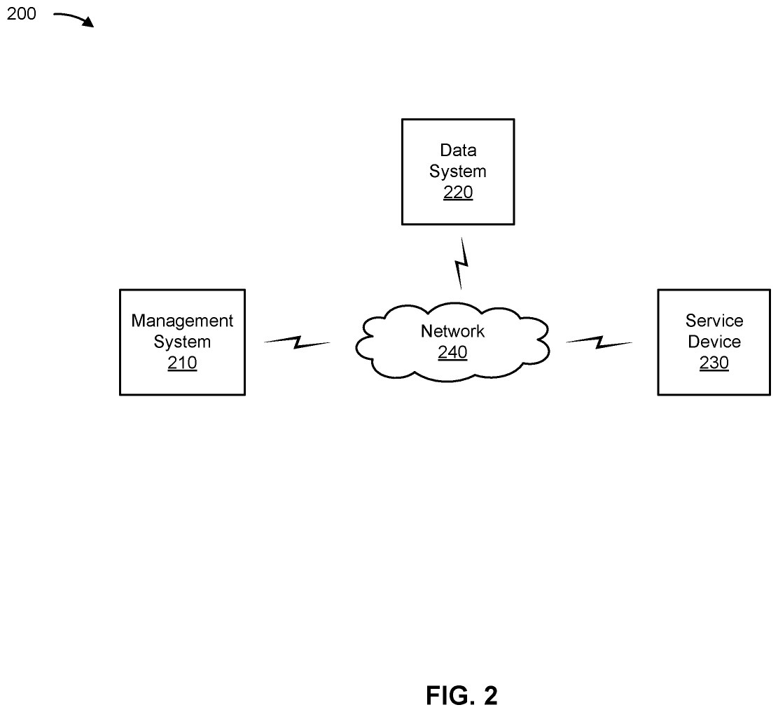

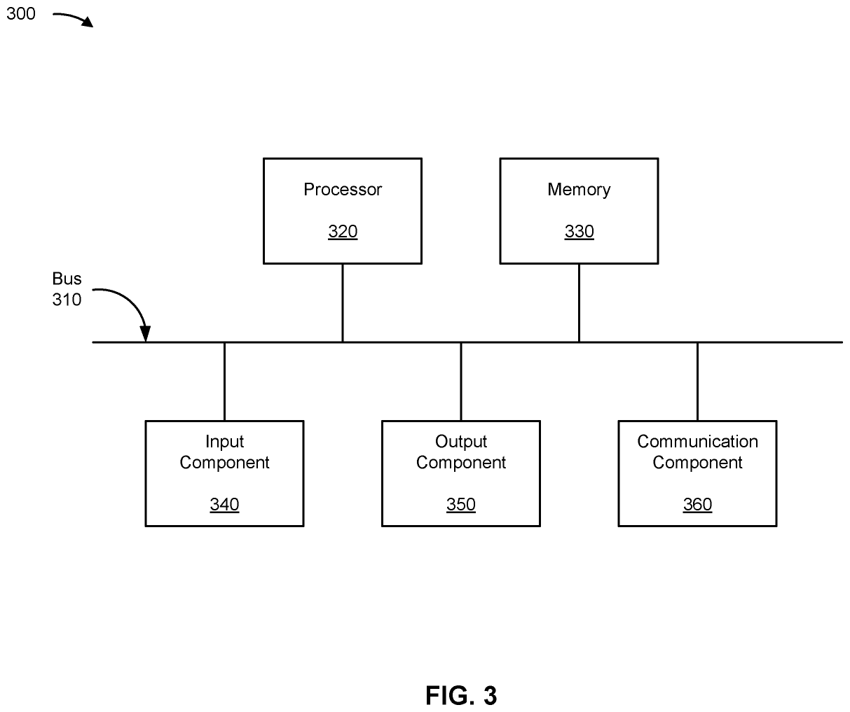

FIGS. 1A-1C are diagrams of an example 100 associated with communicating via a communication channel identified from an ETL process. As shown in FIGS. 1A-1C, example 100 includes a management system, one or more data systems, and one or more service devices. These devices are described in more detail in connection with FIGS. 2 and 3.

In some implementations, the management system may include, may be included in, or may use to perform operations described herein, a cloud-based serverless platform. The cloud-based serverless platform may include a first cloud-based serverless compute function, a second cloud-based serverless compute function, a first cloud-based container, a second cloud-based container, and a cloud-based ETL service, as shown. In some implementations, the management system may be non-cloud-based, may include a combination of cloud-based and non-cloud-based components, or may include different cloud-based components from those shown.

The management system may be associated with an organization that facilitates the transmission of communications (e.g., marketing communications) on behalf of one or more entities. In some implementations, the entities may be car dealerships or another type of entity that engages in the sale of goods or services to individuals (as used herein, an “individual” may refer to a single person or a group of people). For example, an entity and an individual may have performed actions relating to a potential transaction (e.g., for purchasing a vehicle) between the individual and the entity. Thus, communications, facilitated by the organization on behalf of the entity, may be targeted to enticing the individual to conduct the transaction with the entity.

An entity may employ a data system in which the entity can log data for events involving interactions between the entity and an individual. Using the example of a car dealership, a first event may include the individual filling out a questionnaire when the individual visits the car dealership for the first time, a second event may include the individual providing a driver's license, a third event may include the individual test driving a particular vehicle, a fourth event may include the individual submitting a financing application, and so forth. The entity may log data for tens, or even hundreds, of events for a single user. In some implementations, the data system may be a customer relationship management (CRM) system. The management system may have access to data logged in multiple entities' systems through application programming interfaces (APIs).

As shown in FIG. 1A, and by reference number 105, the management system may obtain (e.g., receive) raw data from one or more data systems associated with one or more entities. For example, the management system may obtain raw data from a data system via an API endpoint (e.g., a uniform resource locator (URL)) associated with the data system. In some implementations, to obtain raw data from a data system, the management system may receive the raw data via a webhook endpoint (e.g., a URL). For example, when a new event is logged in the data system, the data system may transmit a request indicating the new event to the webhook endpoint. In some implementations, to obtain raw data from a data system, the management system may transmit, via an API endpoint of the data system, a request for the raw data, and the management system may receive, via the API endpoint, a response indicating the raw data. In some implementations, the raw data may be in a JavaScript Object Notation (JSON) format.

In some implementations, the management system may obtain the raw data using a gateway (e.g., a gateway device of the management system). For example, the gateway may handle communications to and from one or more data systems. Additionally, or alternatively, the management system may obtain the raw data using a first cloud-based serverless compute function. For example, the first cloud-based serverless compute function may be triggered by a request (e.g., a hypertext transfer protocol (HTTP) request) made via the gateway (e.g., the request may indicate the raw data).

The raw data may indicate events data indicating a series of events involving interactions between one or more entities (e.g., multiple entities) and one or more individuals (e.g., multiple individuals). Additionally, or alternatively, the raw data may indicate identity data for the individuals. Additionally, or alternatively, the raw data may identify the entities associated with the raw data (e.g., using entity identifier numbers). For simplicity, the description herein may be in terms of the raw data indicating events data involving a single entity and a single individual, indicating identity data for the individual, and/or identifying the entity. For each event in the series of events, the events data may indicate a date of the event, a time of the event, data provided by the individual in connection with the event, and/or a description of the event, among other examples. The identity data may indicate basic information associated with the individual, demographic information associated with the individual, or the like. For example, the identity data may indicate the individual's name, address, phone number, email address, age, occupation, annual income, amount of debt, credit score, marital status, and/or number of children, among other examples.

As shown by reference number 110, the management system may load the raw data into a first container. The first container may be a type of digital storage. In some implementations, the first container may use a first cloud-based service. For example, the first container may be a cloud-based storage unit. In some implementations, the management system, using the first cloud-based serverless compute function, may load the raw data into the first container. Loading the raw data into the first container may initiate an ETL process. For example, loading the raw data into the first container may trigger the ETL process to be performed using a second cloud-based service. Using the second cloud-based service to perform the ETL process provides efficient, scalable processing of the raw data despite the very large size of the raw data.

As shown by reference number 115, the management system may extract the raw data from the first container. For example, the management system may extract the raw data from the first container in connection with an extract phase of the ETL process. The management system may extract the raw data from the first container using the second cloud-based service. In some implementations, the management system may extract all of the raw data stored in the first container. In some implementations, the management system may extract a portion of the raw data stored in the first container (e.g., raw data that relates to a particular date range, relates to one or more particular entities, relates to one or more particular individuals, relates to a particular event, or the like). For example, the management system may extract a portion of the raw data that relates to individuals who have not received, or interacted with, a communication in more than a threshold time period (e.g., a threshold number of weeks, days, hours, or the like).

As shown in FIG. 1B, and by reference number 120, the management system may process the raw data that is extracted. For example, the management system may process the raw data in connection with a transform phase of the ETL process. The management system may process the raw data using the second cloud-based service. The management system may process the raw data to determine one or more parameters for a communication that is to be sent to the individual. The parameters may include a communication type for the communication, a communication channel for the communication, a content for the communication, and/or a timing for the communication (e.g., a time of day that the communication should be sent to the individual). The communication type may be a text message, an email message, or an automated phone call, among other examples. The communication channel may include a communication transmission service (e.g., a service that transmits communications on behalf of others).

The management system may process the raw data to determine the parameters based on the events data and/or the identity data indicated in the raw data. In some implementations, the management system may select, based on processing the events data and/or the identity data, a particular communication type from a set of communication type options (e.g., text message, email message, automated phone call, or the like) and/or a particular communication channel from a set of communication channel options (e.g., a first communication transmission service, a second communication transmission service, and so forth).

In some implementations, when processing the raw data, the management system may determine, based on the events data and/or the identity data, a communication-type preference for the individual. The communication-type preference may be text message (e.g., a short message service (SMS) message), email, or automated phone call, among other examples. As an example, the events data may indicate one or more events in which the individual provided a preferred contact method (e.g., by phone, email, text message, or the like), may indicate one or more events in which the individual provided consent to receive communications via a particular communication type, and/or may indicate one or more events in which the individual provided contact information (e.g., provided a phone number or an email address). As another example, the identity data may indicate whether attributes associated with the individual (e.g., age, occupation, or number of children) are associated with a preference for a particular communication type (e.g., based on the responsiveness of other individuals with similar attributes to particular communication types). For example, if the individual's age meets a threshold, the management system may determine that the communication-type preference for the individual is email, but if the individual's age is below the threshold, the management system may determine that the communication-type preference for the individual is text message. The management system may determine whether the attributes associated with the individual are associated with a preference for a particular communication type using a machine learning model (e.g., a regression model, a classification model, a deep learning model, or the like) or a collaborative filtering technique, among other examples.

The management system may determine the communication type and/or the communication channel for the communication based on the communication-type preference. For example, the communication type that is determined may be the communication-type preference. In some implementations, the communication-type preference may indicate a communication transmission service for the communication channel. For example, a text message communication-type preference may indicate that the communication channel should be a communication transmission service that provides text message transmission, whereas an email communication-type preference may indicate that the communication channel should be a communication transmission service that provides email transmission. In some implementations, the management system may determine the communication channel based on a communication-type preference of the entity and/or a communication transmission service preference of the entity. For example, based on an identity of the entity, indicated in the raw data, the management system may look up a communication-type preference of the entity and/or a communication transmission service preference of the entity in data stored by the management system, and the communication channel may be based on the entity's preferred communication type and/or preferred communication transmission service.

In some implementations, when processing the raw data, the management system may determine, based on the events data and/or the identity data, an object or service of interest to the individual and/or a level of interest that the individual has for the object or service. For example, if the events data indicates multiple events relating to the individual test driving a particular sports car, and if the identity data indicates that the individual has an annual income that is similar to annual incomes of other purchasers of the sports car, then the management system may determine that the individual is interested in the sports car and/or has a high level of interest in the sports car. In some implementations, to determine the object or service of interest and/or the level of interest, the management system may process the raw data using a behavioral analysis technique (e.g., analyzing durations of events, quantities of events, frequencies of events, or the like), a clustering technique, an association rule mining technique (e.g., identifying sequences of events that lead to a purchase of the object or service), a machine learning model (e.g., a regression model, a classification model, a deep learning model, or the like), a predictive analytics technique, and/or a collaborative filtering technique, among other examples.

The management system may determine the content for the communication based on the object or service and/or the level of interest. For example, the content may reference the object or service, may include media (e.g., an image or a video), or a link to media, relating to the object or service, may include a description of features of the object or service, or the like. The content may include first content if the level of interest is in a first range or satisfies a first threshold, second content if the level of interest is in a second range or satisfies a second threshold, and so forth. For example, the content may include a description of a financing offer, include a link to a financing application, or include a link to a checkout page or a shopping cart with the object or service if the level of interest is higher (e.g., in a first range), or the content may include a description of features of the object or service, a link to a web page relating to the object or service, or a link to a customer assistance session if the level of interest is lower (e.g., in a second range). In some implementations, the content may indicate a most-recent event indicated by the events data (e.g., if the most-recent event was a test drive of a sports car, the content may include text that states, “Thanks for test driving a sports car with us.”).

In some implementations, when processing the raw data, the management system may determine, based on the events data and/or the identity data, one or more times at which the individual has a probability (e.g., greater than a threshold) of being available or a probability (e.g., greater than a threshold) of being responsive. For example, the events data may indicate one or more events in which the individual provided a preferred contact time, may indicate one or more events in which the individual provided the hours that the individual works, and/or may indicate times that one or more events (e.g., the individual visiting a location of the entity, such as a showroom) occurred (e.g., which may indicate that the individual does not work at those times). As another example, the identity data may indicate whether attributes associated with the individual (e.g., age, occupation, or number of children) are associated with availability or responsiveness (e.g., based on the responsiveness of other individuals with similar attributes to communications). The management system may determine whether the attributes associated with the individual are associated with a preference for a particular communication type using a machine learning model (e.g., a regression model, a classification model, a deep learning model, or the like) or a collaborative filtering technique, among other examples.

The management system may determine the timing for the communication based on the times at which the individual has the probability of being available and/or the probability of being responsive. For example, the management system may determine that the timing for the communication is a time associated with a highest probability of the individual being available and/or a highest probability of the individual being responsive.

As shown by reference number 125, the management system may transform the raw data that is extracted into communication data. For example, the management system may transform the raw data in connection with the transform phase of the ETL process. The management system may transform the raw data using the second cloud-based service. The management system, to transform the raw data into the communication data, may generate the communication data based on the raw data (e.g., based on the processing of the raw data described at reference number 120).

The transformation of the raw data into the communication data may be in accordance with the processing of the raw data by the management system. Moreover, the transformation of the raw data into the communication data may coincide with, or include, the processing of the raw data by the management system. The transformation of the raw data into the communication data may alter portions of the raw data, discard portions of the raw data, or introduce new data that is based on the raw data. For example, the communication data may indicate the determined communication type, the determined communication channel (e.g., an endpoint for the communication channel, as described below), the determined timing, the determined content (e.g., which may include information that is based on the events data and/or the identity data), and/or contact information for the individual (e.g., a phone number or an email address indicated by the identity data). By transforming the raw data into the communication data, significant amounts of the raw data are discarded and/or reduced in size, thereby reducing an amount of computing resources needed to handle the communication data relative to the raw data.

In some implementations, when transforming the raw data into the communication data, the management system may use a format for the communication data that is used for the communication channel (i.e., the communication data may be in the format used for the communication channel). For example, a first communication channel may use a first format, a second communication channel may use a second format, and so forth. As an example, for a particular communication transmission service, the management system may use a format for the communication data that is accepted by the communication transmission service (e.g., the communication data may need to be in a first format to be processed and/or understood by a first communication transmission service, the communication data may need to be in a second format to be processed and/or understood by a second communication transmission service, and so forth). For example, the format for the communication data may be a format that is used by an API for the communication channel (e.g., the format for the communication data may adhere to a structure required by an API of a communication transmission service).

As shown in FIG. 1C, and by reference number 130, the management system may load the communication data into a second container, in a similar manner as described above with respect to reference number 110. For example, the management system may load the communication data into the second container in connection with a load phase of the ETL process. In some implementations, the second container may also use the first cloud-based service that is used by the first container. Loading the communication data into the second container may initiate a communication action. For example, loading the communication data into the second container may trigger a second cloud-based serverless compute function that is to perform the communication action. As an example, loading the communication data into the second container may trigger the management system, using the second cloud-based serverless compute function, to obtain (e.g., extract) the communication data from the second container, as shown by reference number 135, and to perform the communication action using the communication data.

As shown by reference number 140, the management system may transmit the communication data (e.g., upon obtaining the communication data from the second container). For example, the management system, using the second cloud-based serverless compute function, may transmit the communication data. The management system may transmit the communication data for an endpoint for the communication channel, which may be implemented by a service device. In some implementations, the management system may transmit the communication data to a gateway (e.g., a gateway device of the management system), which may be the gateway described above or a different gateway, and the gateway may transmit the communication data to the endpoint for the communication channel. The management system may transmit the communication data in connection with the communication action (e.g., transmission of the communication data may be the communication action).

The endpoint for the communication channel may be an API endpoint (e.g., a URL) for the communication channel (e.g., for the communication transmission service). In some implementations, the management system (and/or the gateway) may identify the endpoint based on the communication channel (e.g., using a look-up table or a mapping of endpoints to communication channels). Transmission of the communication data to the endpoint for the communication channel may cause transmission of the communication (e.g., by the service device for the communication transmission service). For example, the communication transmission service may transmit the communication in accordance with the communication data. The communication may include the content and may use the communication type indicated by the communication data. In some implementations, the management system (and/or the gateway) may time transmission of the communication data in accordance with the determined timing (e.g., so that transmission of the communication data causes transmission of the communication in accordance with the timing). In some implementations, the communication data may indicate the timing, and the communication transmission service may queue or schedule the communication in accordance with the timing. In some implementations, the management system may transmit the communication in accordance with the communication data (e.g., without using the communication transmission service).

By using an optimal communication type, communication channel, content, and/or timing for the communication, a probability that the individual will engage with the communication is improved. In this way, computing resources and network resources used for transmitting the communication are utilized more efficiently.

As indicated above, FIGS. 1A-1C are provided as an example. Other examples may differ from what is described with regard to FIGS. 1A-1C.

FIG. 2 is a diagram of an example environment 200 in which systems and/or methods described herein may be implemented. As shown in FIG. 2, environment 200 may include a management system 210, a data system 220, a service device 230, and a network 240. Devices of environment 200 may interconnect via wired connections, wireless connections, or a combination of wired and wireless connections.

The management system 210 may include one or more devices capable of receiving, generating, storing, processing, providing, and/or routing information associated with communicating via a communication channel identified from an ETL process, as described elsewhere herein. The management system 210 may include a communication device and/or a computing device. For example, the management system 210 may include a server, such as an application server, a client server, a web server, a database server, a host server, a proxy server, a virtual server (e.g., executing on computing hardware), or a server in a cloud computing system. In some implementations, the management system 210 may include computing hardware used in a cloud computing environment.

The data system 220 may include one or more devices capable of receiving, generating, storing, processing, providing, and/or routing information associated with raw data used in an ETL process, as described elsewhere herein. The data system 220 may include a communication device and/or a computing device. For example, the data system 220 may include a server, such as an application server, a client server, a web server, a database server, a host server, a proxy server, a virtual server (e.g., executing on computing hardware), or a server in a cloud computing system. In some implementations, the data system 220 may include computing hardware used in a cloud computing environment.

The service device 230 may include one or more devices capable of receiving, generating, storing, processing, providing, and/or routing information associated with communicating via a communication channel identified from an ETL process, as described elsewhere herein. The service device 230 may include a communication device and/or a computing device. For example, the service device 230 may include a server, such as an application server, a client server, a web server, a database server, a host server, a proxy server, a virtual server (e.g., executing on computing hardware), or a server in a cloud computing system. In some implementations, the service device 230 may include computing hardware used in a cloud computing environment.

The network 240 may include one or more wired and/or wireless networks. For example, the network 240 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 240 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with communicating via a communication channel identified from an ETL process. The device 300 may correspond to management system 210, data system 220, and/or service device 230. In some implementations, management system 210, data system 220, and/or service device 230 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320.

The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

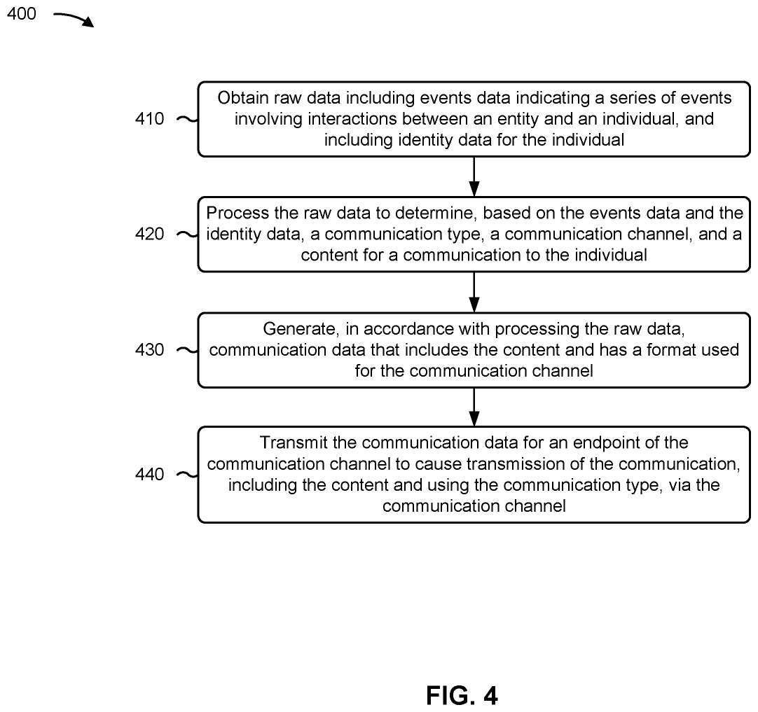

FIG. 4 is a flowchart of an example process 400 associated with communicating via a communication channel identified from an ETL process. In some implementations, one or more process blocks of FIG. 4 may be performed by the management system 210. In some implementations, one or more process blocks of FIG. 4 may be performed by another device or a group of devices separate from or including the management system 210, such as the data system 220 and/or the service device 230. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include obtaining raw data including events data indicating a series of events involving interactions between an entity and an individual, and including identity data for the individual (block 410). For example, the management system 210 (e.g., using processor 320, memory 330, and/or communication component 360) may obtain raw data including events data indicating a series of events involving interactions between an entity and an individual, and including identity data for the individual, as described above in connection with reference number 105 of FIG. 1A. As an example, the raw data may be received via a webhook endpoint.

As further shown in FIG. 4, process 400 may include processing the raw data to determine, based on the events data and the identity data, a communication type, a communication channel, and a content for a communication to the individual (block 420). For example, the management system 210 (e.g., using processor 320 and/or memory 330) may process the raw data to determine, based on the events data and the identity data, a communication type, a communication channel, and a content for a communication to the individual, as described above in connection with reference number 120 of FIG. 1B. As an example, processing of the raw data may be used to identify a particular communication type from a set of communication type options (e.g., text message, email message, automated phone call, or the like) and/or a particular communication channel from a set of communication channel options (e.g., a first a communication transmission service, a second a communication transmission service, and so forth).

As further shown in FIG. 4, process 400 may include generating, in accordance with processing the raw data, communication data that includes the content and has a format used for the communication channel (block 430). For example, the management system 210 (e.g., using processor 320 and/or memory 330) may generate, in accordance with processing the raw data, communication data that includes the content and has a format used for the communication channel, as described above in connection with reference number 125 of FIG. 1B. As an example, the communication data may indicate a determined communication type, a determined communication channel (e.g., an endpoint for the communication channel), a determined timing, a determined content (e.g., which may include information that is based on the events data and/or the identity data), and/or contact information for the individual (e.g., a phone number or an email address indicated by the identity data).

As further shown in FIG. 4, process 400 may include transmitting the communication data for an endpoint of the communication channel to cause transmission of the communication, including the content and using the communication type, via the communication channel (block 440). For example, the management system 210 (e.g., using processor 320, memory 330, and/or communication component 360) may transmit the communication data for an endpoint of the communication channel to cause transmission of the communication, including the content and using the communication type, via the communication channel, as described above in connection with reference number 140 of FIG. 1C. As an example, the endpoint may be an API endpoint associated with a communication transmission service.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1C. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A system for communicating via a communication channel based on an extract, transform, and load (ETL) process, the system comprising:
one or more memories; and
one or more processors, communicatively coupled to the one or more memories, configured to:
obtain, via a first gateway network device of the system, raw data including events data indicating a series of events involving interactions between an entity and an individual, and including identity data for the individual,
wherein obtaining the raw data is triggered by a computer network request associated with a computer network protocol;
load the raw data into a first container;
initiate the ETL process based on loading the raw data into the first container,
wherein loading the raw data into the first container triggers the ETL process;
extract, in connection with an extract phase of the ETL process, a portion of the raw data from the first container that is related to a particular individual who has not received or interacted with a communication in more than a threshold time period;
process, in connection with a transform phase of the ETL process, the extracted raw data to determine, based on the events data and the identity data, a communication type, a communication channel, and a content for a communication to the particular individual;
transform, in connection with the transform phase of the ETL process, the extracted raw data into communication data that includes the content, includes timing information for the communication data to be transmitted, and has a format used for the communication channel,
wherein the timing information is determined based on processing the extracted raw data;
load, in connection with a load phase of the ETL process, the communication data into a second container to initiate a communication action,
wherein loading the communication data into the second container triggers the communication action; and
transmit, via a second gateway network device of the system, in connection with the communication action, the communication data to an endpoint of the communication channel to cause a communication transmission service associated with the communication channel to transmit the communication that includes the content, using the communication type indicated by the communication data.

2. The system of claim 1, wherein the one or more processors, to process the extracted raw data, are configured to:
select, based on the events data and the identity data, the communication type from a set of communication type options and the communication channel from a set of communication channel options.

3. The system of claim 1, wherein the first container and the second container use a first cloud-based service, and the ETL process uses a second cloud-based service.

4. The system of claim 1, wherein the one or more processors, to process the extracted raw data, are configured to:
determine, based on the events data and the identity data, one or more of:
an object or service of interest to the particular individual, or
a level of interest that the particular individual has for the object or service,
wherein the content is based on at least one of the object or service, or the level of interest.

5. The system of claim 1, wherein the one or more processors, to process the extracted raw data, are configured to:
determine, based on the events data and the identity data, a communication-type preference for the particular individual,
wherein the communication type and the communication channel are based on the communication-type preference.

6. The system of claim 1, wherein the extracted raw data identifies the entity, and
wherein the one or more processors, to process the extracted raw data, are configured to:
determine the communication channel based on at least one of a communication-type preference of the entity or a communication transmission service preference of the entity.

7. The system of claim 1, wherein the communication type is a text message or an email message.

8. (canceled)

9. A method of communicating via a communication channel based on an extract, transform, and load (ETL) process, comprising:
obtaining, by a device and via a first gateway network device associated with the device, raw data including events data indicating a series of events involving interactions between an entity and an individual, and including identity data for the individual,
wherein obtaining the raw data is triggered by a computer network request associated with a computer network protocol;
loading, by the device, the raw data into a first container;
initiating, by the device, the ETL process based on loading the raw data into the first container,
wherein loading the raw data into the first container triggers the ETL process;
extracting, by the device and based on the ETL process, a portion of the raw data from the first container that is related to a particular individual who has not received or interacted with a communication in more than a threshold time period;
processing, by the device, the extracted raw data to determine, based on the events data and the identity data, a communication type, a communication channel, and a content for a communication to the particular individual;
transforming, by the device and based on processing the extracted raw data, communication data that includes the content, includes timing information for the communication data to be transmitted, and has a format used for the communication channel,
wherein the timing information is determined based on processing the extracted raw data;
loading, by the device and based on the ETL process, the communication data into a second container to initiate a communication action,
wherein loading the communication data into the second container triggers the communication action; and
transmitting, by the device and via a second gateway network device associated with the device, the communication data for an endpoint of the communication channel to cause a communication transmission service associated with the communication channel to transmit the communication that includes the content, using the communication type indicated by the communication data.

10. The method of claim 9, wherein the extracted raw data is obtained using a first cloud-based serverless compute function, and
wherein the communication data is transmitted using a second cloud-based serverless compute function.

11. (canceled)

12. The method of claim 9, wherein processing the extracted raw data comprises:
determining, based on the events data and the identity data, one or more of:
an object or service of interest to the particular individual, or
a level of interest that the particular individual has for the object or service,
wherein the content is based on at least one of the object or service, or the level of interest.

13. The method of claim 9, wherein processing the extracted raw data comprises:
selecting, based on the events data and the identity data, the communication type from a set of communication type options and the communication channel from a set of communication channel options.

14. The method of claim 9, wherein the format is used by an application programming interface (API) for the communication channel.

15. The method of claim 9, wherein the extracted raw data is from a customer relationship management (CRM) system of the entity.

16. A non-transitory computer-readable medium storing a set of instructions for communicating via a communication channel based on an extract, transform, and load (ETL) process, the set of instructions comprising:
one or more instructions that, when executed by one or more processors of a device, cause the device to:
obtain, via a first gateway network device associated with the device, raw data indicating at least one of:
events data indicating a series of events involving interactions between an entity and an individual, or
identity data for the individual,
wherein obtaining the raw data is triggered by a computer network request associated with a computer network protocol;
load the raw data into a first container;
initiate the ETL process based on loading the raw data into the first container,
wherein loading the raw data into the first container triggers the ETL process;
extract, based on the ETL process, a portion of the raw data from the first container that is related to a particular individual who has not received or interacted with a communication in more than a threshold time period;
process the extracted raw data to determine, based on at least one of the events data or the identity data, a communication channel and a content for a communication to the particular individual;
transform, based on processing the extracted raw data, communication data that has a format used for the communication channel and that includes timing information for the communication data to be transmitted,
wherein the timing information is determined based on processing the extracted raw data;
load, based on the ETL process, the communication data into a second container to initiate a communication action,
wherein loading the communication data into the second container triggers the communication action; and
transmit, via a second gateway network device associated with the device, the communication data for an endpoint of the communication channel to cause a communication transmission service associated with the communication channel to transmit the communication that includes the content, using the communication type indicated by the communication data.

17. The non-transitory computer-readable medium of claim 16, wherein the one or more instructions, that cause the device to obtain the extracted raw data, cause the device to:
receive the extracted raw data via a webhook endpoint.

18. The non-transitory computer-readable medium of claim 16, wherein the one or more instructions, that cause the device to obtain the extracted raw data, cause the device to:
transmit, via an application programming interface (API) endpoint, a request for the extracted raw data; and
receive, via the API endpoint, a response indicating the extracted raw data.

19. The non-transitory computer-readable medium of claim 16, wherein the one or more instructions, that cause the device to process the extracted raw data, cause the device to:
select, based on at least one of the events data or the identity data, the communication channel from a set of communication channel options.

20. (canceled)

21. The system of claim 1, wherein the first gateway network device and the second gateway network device may be the same gateway network device.

22. The system of claim 1, wherein the determined timing for the communication data is determined based on times at which the particular individual receiving the communication data has a probability of being available,
wherein the probability is greater than a threshold probability.

23. The system of claim 1, wherein the endpoint is identified based on the communication channel by using a table or a mapping of endpoints to communication channels.
